(19) United States
(12) Patent Application Publication
(10) Pub. No.: US 2017/0208991 A1
(43) Pub. Date: Jul. 27, 2017

(54) TRAVELING BOTTLE WARMER BAG SYSTEMS

(71) Applicant: Annette Dwyer, Spanaway, WA (US)

(72) Inventor: Annette Dwyer, Spanaway, WA (US)

(21) Appl. No.: 15/004,896

(22) Filed: Jan. 23, 2016

(51) Int. Cl. A47J 36/24; H05B 6/64; B65D 81/38

(52) U.S. Cl. CPC A47J 36/2411; B65D 81/389; H05B 6/6408

(57) ABSTRACT

A traveling bottle warmer bag system for keeping contents stored in containers warm for extended periods of time. The bag has three insulated layers of material that can be warmed in a microwave and stored yet retaining heat energy. The bag includes a drawstring in order to tightly close the bag after a bottle has been placed within the innermost layer to resist heat loss. When used, it eliminates the worry of a baby's bottle, tanning lotion, or other item becomes cold while traveling.

### CROSS-REFERENCE TO RELATED APPLICATION

The present application is related to and claims priority from prior provisional application Ser. No. 62/152,367, filed Apr. 24, 2015 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of containment means and more specifically relates to a traveling bottle warmer bag system.

### 2. DESCRIPTION OF RELATED ART

A container is a basic tool, consisting of any device creating a partially or fully enclosed space that can be used to contain, store, and transport objects or materials. Things kept inside of a container are protected by being inside of its structure. The term is most frequently applied to devices made from materials that are durable and at least partly rigid. A bag (also known as a sack) is a common tool in the form of a non-rigid container. The use of bags predates recorded history, with the earliest bags being no more than lengths of animal skin, cotton, or woven plant fibers, folded up at the edges and secured in that shape with strings of the same material. Despite their simplicity, bags have been fundamental for the development of human civilization, as they allow people to easily collect loose materials such as berries or food grains, and to transport more items than could readily be carried in the hands. Bags have found many uses but most are not multi-functional.

Many individuals have children. These children need to be nourished many times a day. Baby bottles may be heated in a microwave in order to get the milk warm enough for a child to enjoy. Without access to a microwave, heating a bottle may be virtually impossible. Further, many people tan. People who enjoy tanning may prefer heated massage oil, and without a way to heat, it they may be left uncomfortable and frustrated. This is not desirable; a means to safely heat and store ‘as heated’ various liquids is needed.

Several attempts have been made to solve the above-mentioned problems such as those found in U.S. Pub. No. 2009/0032516 to Reasor, and U.S. Pat. No. 6,147,337 to Besser U.S. Pat. No. 5,424,519 to Salee; U.S. Pat. No. 8,839,782 to Hess; and U.S. Pat. No. 7,176,426 to Ramirez. This art is representative of containment means. However, none of the above inventions and patents, taken either singly or in combination, is seen to describe the invention as claimed.

Preferably, an insulated heating bag system (traveling bottle warmer bag system) should provide users with a means to keep baby bottles, tanning lotion, etc. warm for extended periods of time and, yet would operate reliably and be manufactured at a modest expense. Thus, a need exists for a reliable traveling bottle warmer bag system to avoid the above-mentioned problems.

### BRIEF SUMMARY OF THE INVENTION

In view of the foregoing disadvantages inherent in the known containment means art, the present invention provides a novel traveling bottle warmer bag system. The general purpose of the present invention, which will be described subsequently in greater detail is to provide users with a means for keeping object contents warm for extended periods of time.

The present invention provides users with a unique and convenient bag capable of keeping items warm for extended periods of time. It preferably utilizes three insulated layers of material in order to be warmed in a microwave and retain heat. Alternate embodiments may comprise more or less layers. As designed, the device includes a drawstring mechanism in order to tightly close the bag after a bottle has been placed within the innermost layer to resist thermal loss. When used, the apparatus virtually eliminates the worry of a baby's bottle, tanning lotion, or other item becoming cold while traveling. As such, the present invention allows people to retain maximum comfort for themselves and children while away from home.

An insulated heating bag system is disclosed herein, in a preferred embodiment, comprising: a flexible insulated heating bag having an outer surface, at least one insulating layer, an inner surface, an inner volume, and a securer. The insulated heating bag system comprises in functional combination the flexible insulated heating bag; the flexible insulated heating bag is defined by the outer surface, the at least one insulating layer, the inner surface, the inner volume, and the securer.

The at least one insulating layer is positioned between the inner surface and the outer surface. The at least one insulating layer, and the inner surface are located respectively in a series relationship from outside to inside of the flexible insulated heating bag. The outer surface has a bottom and side walls integrally formed forming a partially enclosed space (when tied or the top otherwise being secured). The inner surface defines parameters of the inner volume; the outer surface comprises an enclosed bottom and an open aperture that may be closed via the drawstring. The at least one insulating layer thermally restricts inward and outward movement of heat energy. In this way the at least one insulating layer comprises a means for restricting passage of thermal energy therefrom and thereinto.

The securer comprises a drawstring; the drawstring is held in position within a sleeve with the drawstring accessible for tightening and loosening via at least one aperture opening. The securer is located adjacent a top of the flexible insulated heating bag and the securer is used to close (tightened and tied) and alternately open the inner volume (untied and let loose) allowing access to respectively insulatively store and retrieve for use the at least one object. The inner volume is structured and arranged such that at least one object is able to be placed for removable insulated storage within the flexible insulated heating bag. The at least one object may comprise baby bottles (other contents within containers may also be heated such as lotion and the like); the baby bottles and their contents are able to be kept at a desired stabilized temperature for an extended period of time. The flexible insulated heating bag is microwave-friendly. Flexible insulated heating bag comprises a traveling bottle warmer bag.

A kit is also disclosed including: the flexible insulated heating bag, the baby bottle, and a set of user instructions.

A method of using the insulated heating bag system is also disclosed herein comprising the steps of: opening a flexible insulated heating bag, placing at least one object to be temperature controlled within an inner volume of the flexible insulated heating bag, drawing tight drawstrings to close the inner volume, and heating the at least one object (contents) in a microwave oven. The method may further comprise the steps of removing the at least one object comprising a baby bottle with warmed contents, and feeding a baby the warmed contents. Lotions may be heated in a similar manner and used.

The present invention holds significant improvements and serves as an insulated heating bag system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, traveling bottle warmer bag system, constructed and operative according to the teachings of the present invention.

FIG. 1 shows a perspective view illustrating an insulated heating bag system during an ‘in-use’ condition according to an embodiment of the present invention.

FIG. 2 is a top view illustrating the insulated heating bag system comprising a flexible insulated heating bag (in an open condition) according to an embodiment of the present invention of FIG. 1.

FIG. 3 is a perspective view illustrating the flexible insulated heating bag of the insulated heating bag system as accepting an item (with contents to be heated) according to an embodiment of the present invention of FIGS. 1-2.

FIG. 4 is a perspective view illustrating the insulated heating bag system as for use with a baby bottle with contents therein according to an embodiment of the present invention of FIGS. 1-3.

FIG. 5 is a flowchart illustrating a method of use for the insulated heating bag system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a heating and storage means and more particularly to an insulated heating bag system, entitled traveling bottle warmer bag system, as used to improve the efficiency of keeping an object's contents warm for an extended duration.

Generally speaking, insulated heating bag system of the present invention comprises a unique, highly convenient bag capable of retaining heat energy via three layers of material, allowing users to keep baby bottles, tanning lotion, etc. warm for extended periods of time. The device is preferably comprised of a small bag with three layers of material integrated within the bag material and a drawstring closure mechanism. The three layers work in conjunction to retain heat after being warmed in the microwave.

The first layer can be comprised of a thick, foam-like material. The second layer can be comprised of a filler material capable of retaining most of the heat. The third layer can be comprised of a thin material. All layers are sewn together with the second layer being hidden within the bag. Other materials and layer arrangements may be employed.

The bag can be heated in the microwave for approximately 3 minutes in order to retain an appropriate amount of heat. Once warm, an individual can place a lotion or baby bottle within the bag's interior. The drawstring mechanisms can then be pulled closed in order to secure the bottle within the bag. The bag can help keep the bottle warm while away from home. Users can open the bag at any time via the drawstring units in order to access the container and contents.

Insulated heating bag system may be constructed using nylon, cotton, foam, and other suitable materials. The device may be available in multiple sizes in order to accommodate all user needs and preferences. Further, the bag may be available in wide range of colors, suited for personal preference.

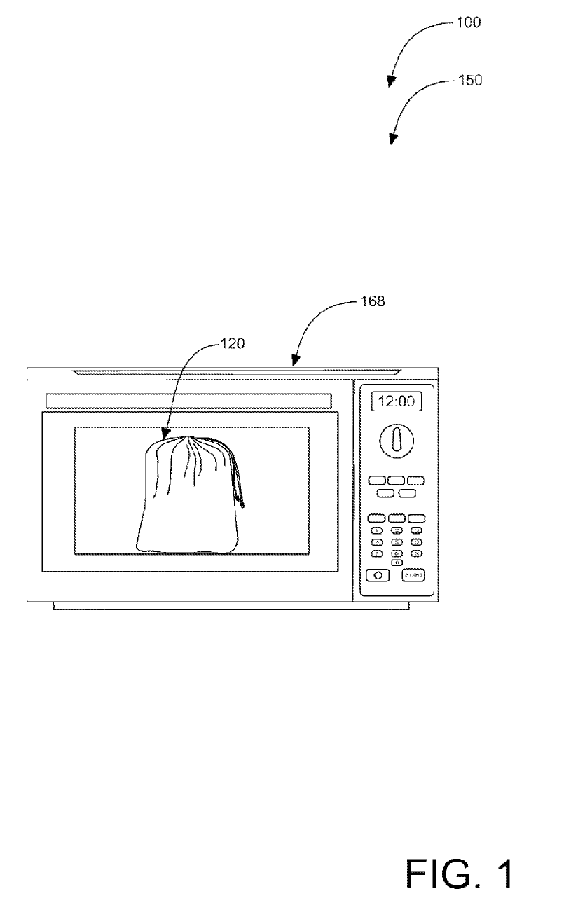

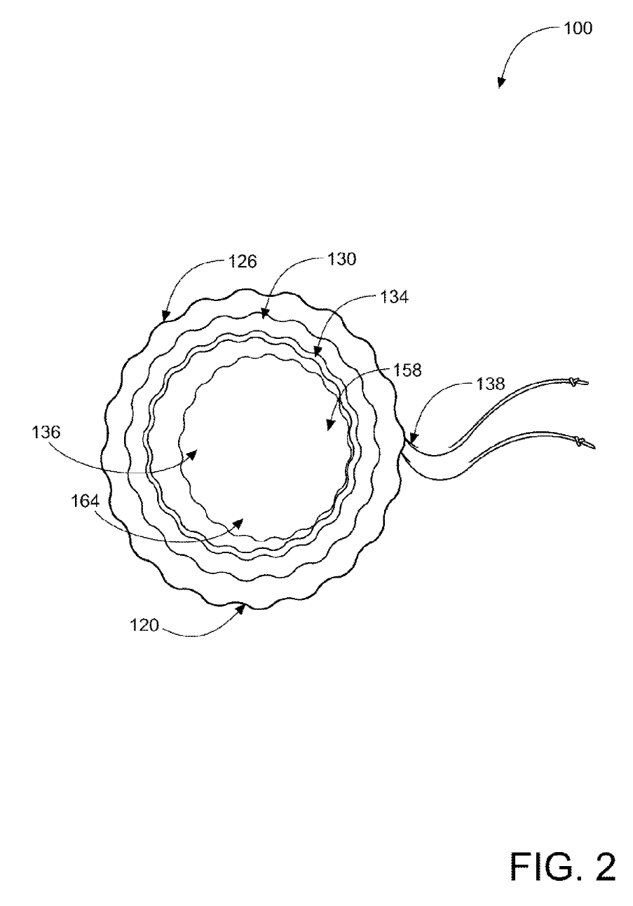

Referring now to the drawings by numerals of reference there is shown in FIGS. 1-4, various views of insulated heating bag system 100 comprising: flexible insulated heating bag 120 having outer surface 126, at least one insulating layer 130, inner surface 134, inner volume 136, and securer 138. Insulated heating bag system 100 comprises flexible insulated heating bag 120; flexible insulated heating bag 120 being defined by outer surface 126, at least one insulating layer 130, inner surface 134, inner volume 136. Relationally speaking, the at least one insulating layer 130 is positioned between inner surface 134 and outer surface 126. The at least one insulating layer 130 thermally restricts inward and outward movement of heat energy.

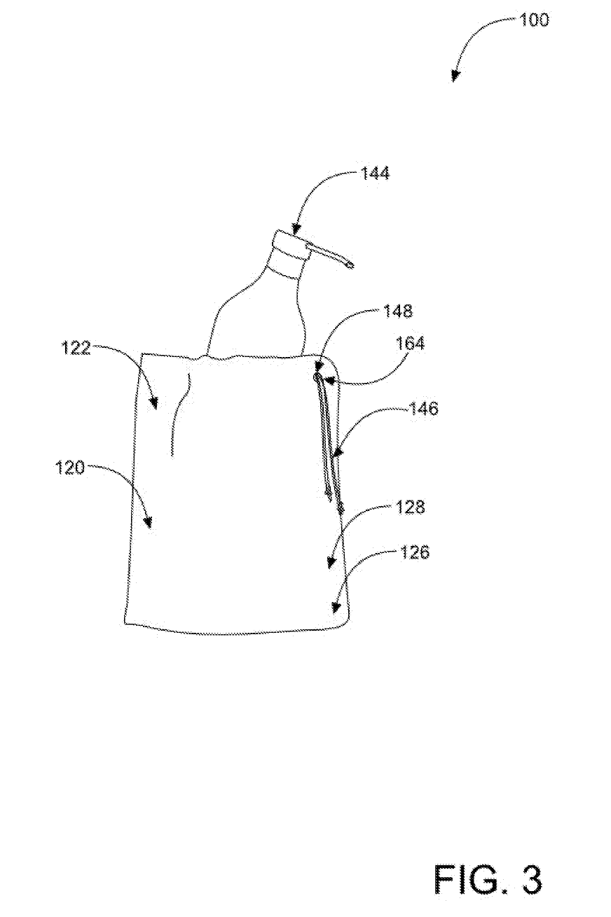

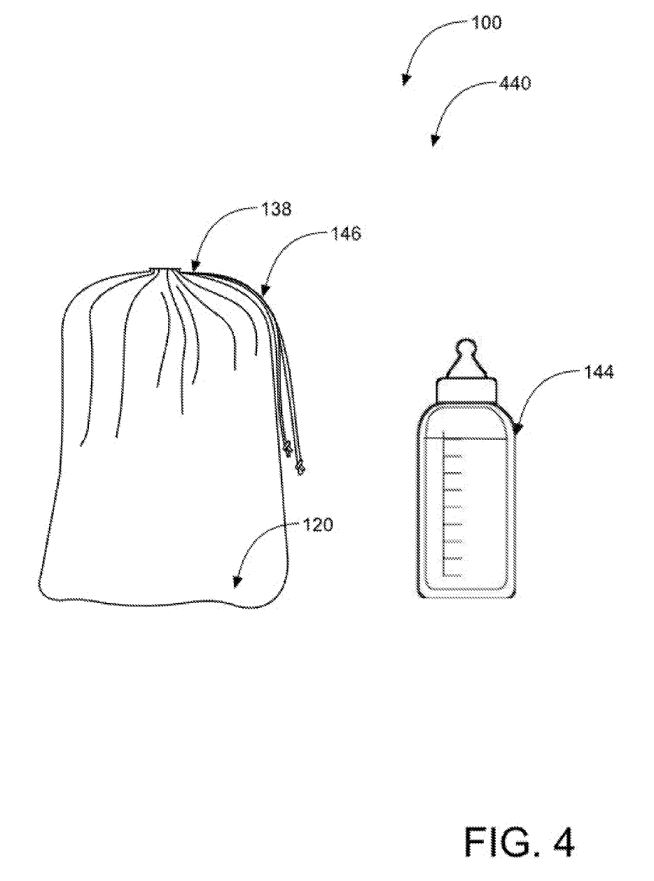

Inner volume 136 is structured and arranged such that at least one object 144 is able to be placed for removable insulated storage within flexible insulated heating bag 120. To accomplish this means securer 138 is located adjacent top 122 of flexible, thus insulated heating bag 120 and securer 138 is able to be used to close and alternately open inner volume 136 allowing access to respectively insulatively store and retrieve for use the at least one object 144, as shown in FIGS. 3 and 4.

Outer surface 126 comprises enclosed bottom 158 and open aperture (in top of flexible insulated heating bag 120) in preferred embodiments. Securer 138, as shown comprises drawstring 146. Outer surface 126 comprises fabric 128; fabric 128 comprises nylon, cotton, and foam. The at least one insulating layer 130 comprises a means for restricting passage of thermal energy therefrom and thereinto. Other securing means may be used. Other materials may be used.

Inner surface 134 may comprise a foam material. Outer surface 126, at least one insulating layer 130, and inner surface 134 are located respectively in a series relationship from outside to inside of flexible insulated heating bag 120. Inner surface 134 defines parameters of inner volume 136. Inner volume 136 is suitably sized to removably contain at least one object 144.

The at least one object 144 may comprise baby bottles; baby bottles and their contents are able to be kept at a desired stabilized temperature for an extended period of time. The at least one object 144 may comprise tanning lotion; tanning lotion is able to be kept at a desired stabilized temperature for an extended period of time. Flexible insulated heating bag 120 is microwave-friendly. Outer surface 126 has a bottom and side walls integrally formed. Drawstring 146 is held in position within sleeve 148 with drawstring 146 accessible for tightening and loosening via at least one aperture opening 164.

It should be noted that insulated heating bag system 100 may be sold as kit 440 comprising the following parts: at least one flexible insulated heating bag 120 at least one baby bottle or other such at least one object 144 for example: baby bottles or tanning lotion or the like; at least one set of user instructions. The kit has instructions such that functional relationships are detailed in relation to the structure of the invention (such that the invention can be used, maintained, or the like in a preferred manner). Insulated heating bag system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

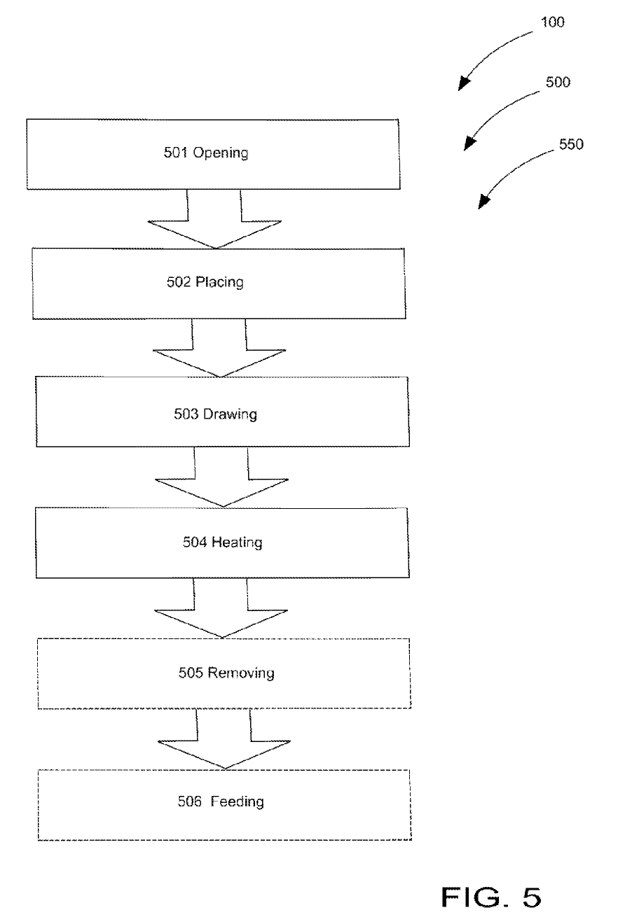

Referring now to FIG. 5 showing flowchart 550 illustrating method of use 500 for insulated heating bag system 100 according to an embodiment of the present invention of FIGS. 1-4.

As shown, method of use 500 may comprise the steps of: step one 501, opening flexible insulated heating bag 120, step two 502 placing at least one object 144 to be temperature controlled within inner volume 136 of flexible insulated heating bag 120, step three 503 drawing tight drawstrings 146 to close inner volume 136, and step four 504, heating at least one object 144 in a microwave oven 168. The method 500 may further comprise the steps five and six, respectively, (505 and 506) of removing the at least one object 144 comprising a baby bottle with warmed contents, and feeding a baby warmed contents. Contents warmed such as lotion may be applied and the like.

It should be noted that steps 505 and 506 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An insulated heating bag system comprising:
a flexible insulated heating bag comprising;
an outer surface;
at least one insulating layer;
an inner surface;
an inner volume; and
a securer;
wherein said insulated heating bag system comprises said flexible insulated heating bag;
wherein said flexible insulated heating bag is defined by said outer surface, said at least one insulating layer, said inner surface, said inner volume, and said securer;
wherein said at least one insulating layer is positioned between said inner surface and said outer surface;
wherein said at least one insulating layer thermally restricts inward and outward movement of heat energy;
wherein said inner volume is structured and arranged such that at least one object is able to be placed for removable insulated storage within said flexible insulated heating bag; and
wherein said securer is located adjacent a top of said flexible insulated heating bag and said securer is used to close and alternately open said inner volume allowing access to respectively insulatively store and retrieve for use said at least one object.

2. The insulated heating bag system of claim 1 wherein said outer surface comprises an enclosed bottom and an open aperture.

3. The insulated heating bag system of claim 1 wherein said securer comprises a drawstring.

4. The insulated heating bag system of claim 1 wherein said outer surface comprises a fabric.

5. The insulated heating bag system of claim 4 wherein said fabric comprises nylon.

6. The insulated heating bag system of claim 4 wherein said fabric comprises cotton.

7. The insulated heating bag system of claim 1 wherein said outer surface comprises foam.

8. The insulated heating bag system of claim 1 wherein said at least one insulating layer comprises a means for restricting passage of thermal energy therefrom and thereinto.

9. The insulated heating bag system of claim 1 wherein said inner surface comprises a foam material.

10. The insulated heating bag system of claim 1 wherein said outer surface, said at least one insulating layer, and said inner surface are located respectively in a series relationship from outside to inside of said flexible insulated heating bag.

11. The insulated heating bag system of claim 1 wherein said inner surface defines parameters of said inner volume.

12. The insulated heating bag system of claim 1 wherein said at least one object comprises baby bottles, said baby bottles and their contents are able to be kept at a desired stabilized temperature for an extended period of time.

13. The insulated heating bag system of claim 1 wherein said at least one object comprises tanning lotion, said tanning lotion is able to be kept at a desired stabilized temperature for an extended period of time.

14. The insulated heating bag system of claim 1 wherein said flexible insulated heating bag is microwave-friendly.

15. The insulated heating bag system of claim 1 wherein said outer surface has a bottom and side walls integrally formed.

16. The insulated heating bag system of claim 1 wherein said drawstring is held in position within a sleeve with said drawstring accessible for tightening and loosening via at least one aperture opening.

17. An insulated heating bag system comprising:
a flexible insulated heating bag comprising;
an outer surface;
at least one insulating layer;
an inner surface;
an inner volume; and
a securer;
wherein said insulated heating bag system comprises said flexible insulated heating bag;
wherein said flexible insulated heating bag is defined by said outer surface, said at least one insulating layer, said inner surface, said inner volume, and said securer;
wherein said at least one insulating layer is positioned between said inner surface and said outer surface;
outer surface, said at least one insulating layer, and said inner surface are located respectively in a series relationship from outside to inside of said flexible insulated heating bag;
wherein said outer surface has a bottom and side walls integrally formed;
wherein said inner surface defines parameters of said inner volume;
wherein said outer surface comprises an enclosed bottom and an open aperture;
wherein said at least one insulating layer thermally restricts inward and outward movement of heat energy;
wherein said at least one insulating layer comprises a means for restricting passage of thermal energy therefrom and thereinto;
wherein said securer comprises a drawstring;
wherein said drawstring is held in position within a sleeve with said drawstring accessible for tightening and loosening via at least one aperture opening;
wherein said inner volume is structured and arranged such that at least one object is able to be placed for removable insulated storage within said flexible insulated heating bag;
wherein said at least one object comprises baby bottles, said baby bottles and their contents are able to be kept at a desired stabilized temperature for an extended period of time;
wherein said flexible insulated heating bag is microwave-friendly;
wherein said flexible insulated heating bag comprises a traveling bottle warmer bag; and
wherein said securer is located adjacent a top of said flexible insulated heating bag and said securer is used to close and alternately open said inner volume allowing access to respectively insulatively store and retrieve for use said at least one object.

18. The insulated heating bag system of claim 17 further comprising a kit including:
said flexible insulated heating bag;
said baby bottle; and
a set of user instructions.

19. A method of using an insulated heating bag system comprising the steps of:
opening a flexible insulated heating bag;
placing at least one object to be temperature controlled within an inner volume of said flexible insulated heating bag;
drawing tight drawstrings to close said inner volume; and
heating said at least one object in a microwave oven.

20. The method of claim 19 further comprising the steps of:
removing said at least one object comprising a baby bottle with warmed contents; and
feeding a baby said warmed contents.
